(19) United States
(12) Patent Application Publication
(10) Pub. No.: US 2011/0243649 A1
(43) Pub. Date: Oct. 6, 2011

(54) BALL JOINT AND METHOD OF MANUFACTURING BALL SEAT

(75) Inventor: Seong-rok Kim, Gyeongsangnam-do (KR)

(73) Assignee: CENTRAL CORPORATION, Changwon-si, Gyeongsangnam-do (KR)

(21) Appl. No.: 13/129,425

(22) PCT Filed: Jul. 1, 2009
(86) PCT No.: PCT/KR2009/003581

§ 371 Date: Jun. 20, 2011

(30) Foreign Application Priority Data
Nov. 21, 2008 (KR) 2008-0116304

(51) Int. Cl. F16C 11/06; B29C 33/38; B29C 45/00

(52) U.S. Cl. 403/122; 264/219

(57) ABSTRACT

A ball joint and a method of manufacturing a ball seat reducing the frictional force between a ball stud and the ball seat, reducing torque of the ball joint, improving performance of the ball joint as a spherical joint, and improving steering performance and the overall feel of riding in a vehicle. A method of manufacturing the ball seat, which has a spherical inner surface in which a ball stud, acting as a spherical joint is seated, includes: forming densely arranged irregular concave features in a processed portion of a mold core, for molding the spherical inner surface of the ball seat, by etching with a chemical solution; and forming the spherical inner surface of the ball seat using the mold core having the irregular concave features.

### TECHNICAL FIELD

The present invention relates to a ball joint for a vehicle and a method of manufacturing a ball seat, and more particularly, to a ball joint and a method of manufacturing a ball seat that are capable of reducing friction torque of the ball joint.

### BACKGROUND ART

Ball joints are widely used as connection means having functions of spherical joints.

FIG. 1 is a cross-sectional view showing a conventional ball joint.

In general, the ball joint includes a ball stud 10 acting as a spherical joint, a ball seat 20 for surrounding the ball stud 10 to protect the ball stud 10 and adjusting the friction force applied between the ball stud 10 and the ball seat 20, a socket 40 for seating the ball stud 10 and the ball seat 20, a plug 30 for sealing the ball stud to prevent the ball stud 10 from being separated downward from the socket due to a compression load, and a dust cover 60 for covering an upper part of the socket 40 to prevent dust from settling onto the ball stud 10. The ball joint is press-fitted into a knuckle or arm 70 to be assembled thereto.

In the ball joint for a vehicle, since the torque of the ball joint has an effect on the feel of riding a vehicle and handling and overall ride of the vehicle, the torque of the ball joint must be adjusted to an appropriate level. When the torque of the ball joint is too high, the ball joint may not smoothly act as a spherical joint to decrease steering performance or feel of riding the vehicle.

Technical attempts for adjusting the torque of the ball joint have been performed in various ways. One attempt is to reduce friction between the ball stud and a spherical inner surface of the ball seat surrounding the ball stud to thereby reduce friction moment of the ball joint.

FIG. 2 is a schematic cross-sectional view showing a bearing having a circular dimple formed in the spherical inner surface to reduce friction moment of the ball joint.

The spherical inner surface of the ball seat 20 may have a circular dimple 21, a lateral holed-groove 22 having a certain width and laterally crossing a spherical inner surface 25 of the ball seat, or a longitudinal holed-groove 23 having a certain width and longitudinally crossing the spherical inner surface 25 of the ball seat. If necessary, all of the circular dimple 21, the lateral holed-groove 22 and the longitudinal holed-groove 23 may be formed in the spherical inner surface of the ball seat 20. The circular dimple 21 and the holed-grooves 22 and 23 cannot substantially reduce the contact area between the ball stud 10 and the ball seat 20. This is because shapes of the dimple and the holed-grooves are standardized. Accordingly, the friction moment of the ball joint is still substantially high.

In addition, the above technical attempt is disclosed in Korean Utility Model Registration No.: 20-131541. According to the Utility Model, cross-shaped lubrication surfaces and circular lubrication grooves are uniformly formed in the spherical inner surface of the ball seat surrounding the ball stud. Lubrication oil is filled into the lubrication surfaces and stored in the lubrication grooves such that the ball stub and the ball seat are well lubricated to reduce friction moment of the ball joint.

However, the conventional art cannot substantially reduce the contact area between the ball stud and the ball seat, and thus, the ball joint still has substantially high friction moment.

### DISCLOSURE

### Technical Problem

In order to solve the foregoing and/or other problems, it is an object of the present invention to provide a ball joint and a method of manufacturing a ball seat that are capable of reducing the friction force applied between a ball stud and the ball seat to reduce torque of the ball joint, and improving performance of the ball joint as a spherical joint to improve steering performance and the overall feel of riding a vehicle.

### Technical Solution

The foregoing and/or other aspects of the present invention may be achieved by providing a ball joint including a ball stud acting as a spherical joint and a ball seat in which the ball stud is seated, characterized in that a spherical inner surface of the ball seat has a plurality of irregular concave features densely disposed to be in point or line contact with an outer circumference of the ball stud.

In addition, another aspect of the present invention may be achieved by providing a method of manufacturing a ball seat having a spherical inner surface in which a ball stud acting as a spherical joint is seated, which includes: a) densely forming a plurality of irregular concave features in a processed portion of a mold core for molding the spherical inner surface of the ball seat through etching by reaction with a chemical solution; and b) forming the spherical inner surface of the ball seat using the mold core having the irregular concave features.

Further, still another aspect of the present invention may be achieved by providing a method of manufacturing a ball seat having a spherical inner surface in which a ball stud acting as a spherical joint is seated, which includes: a) densely forming a plurality of irregular concave features in a processed portion of a mold core for molding the spherical inner surface of the ball seat by a physical process through application of energy or external force to the processed portion; and b) forming the spherical inner surface of the ball seat using the mold core having the irregular concave features.

### Advantageous Effects

According to the present invention, since a spherical inner surface of a bearing has an irregular shape to be in point or line contact with a ball stud so that a contact area between the ball stud and the bearing is remarkably reduced, the torque of a ball joint can be reduced and performance of the ball joint as a spherical joint can be improved to increase handling recovery force, steering performance and the overall feel of riding a vehicle.

### DESCRIPTION OF DRAWINGS

The above and other aspects and advantages of the present invention will become apparent and more readily appreciated from the following description of exemplary embodiments, taken in conjunction with the accompanying drawings of which:

FIG. 1 is a cross-sectional view showing a conventional ball joint;

FIG. 2 is a schematic cross-sectional view showing a bearing having a circular dimple formed at a spherical inner surface thereof to reduce friction moment of a ball joint;

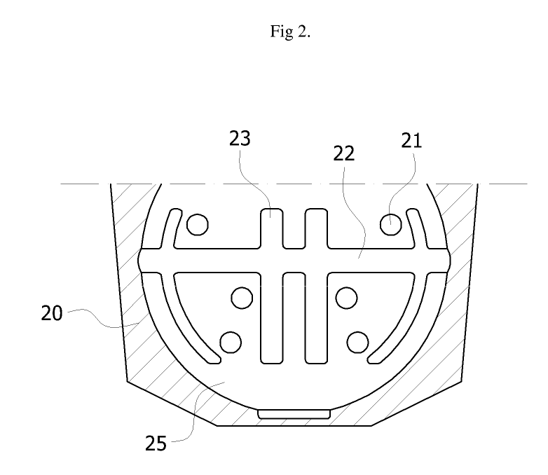

FIG. 3 is a schematic cross-sectional view showing a spherical inner surface of a ball seat of the present invention;

FIG. 4 is a schematic cross-sectional view showing a state in which a ball stud is in contact with the ball seat of the present invention; and

FIG. 5 is a flowchart showing a method of manufacturing a ball seat of the present invention.

### MODE FOR INVENTION

Reference will now be made in detail to the embodiments of the present invention, examples of which are illustrated in the accompanying drawings. However, it will be apparent to those skilled in the art that the following embodiments can be readily understood and modified into various types, and the scope of the present invention is not limited to the embodiments.

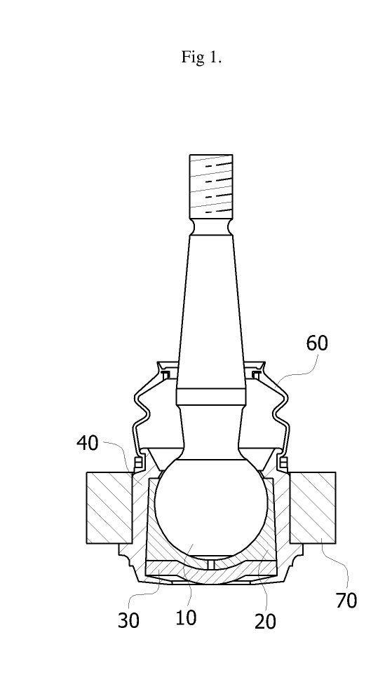

A ball joint of the present invention includes, as shown in FIG. 1, a ball stud 10, a ball seat 20 in which the ball stud 10 is seated, a socket 40 for seating the ball stud 10 and the ball seat 20, a plug 30 for sealing the ball stud 10 to prevent the ball stud 10 from being separated downward from the socket 40 due to a compression load, and a dust cover 60 for covering an upper portion of the socket 40 to prevent dust from settling onto the ball stud 10, basic structures of which are the same as the conventional art. Hereinafter, the ball seat 20 of the present invention will be described.

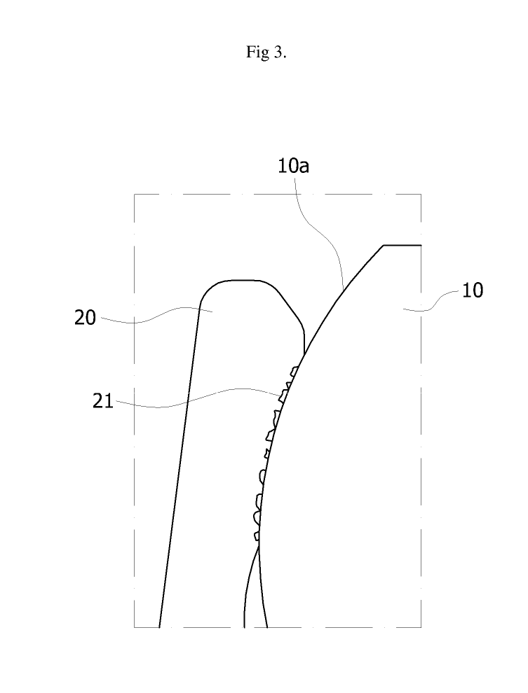

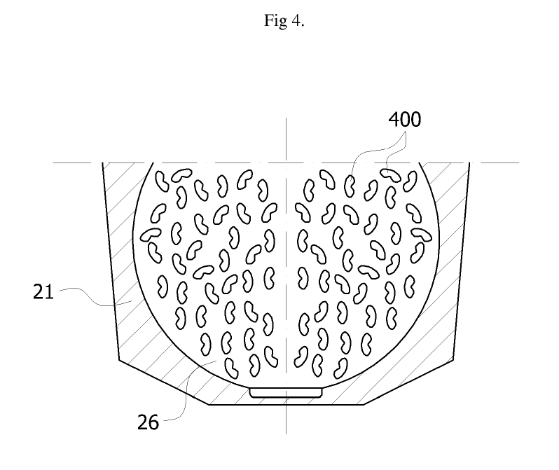

FIG. 3 is a schematic cross-sectional view showing a spherical inner surface of a ball seat of the present invention, and FIG. 4 is a schematic cross-sectional view showing a state in which a ball stud is in contact with the ball seat of the present invention.

The spherical inner surface 21 of the ball seat 20 has an irregular shape similar to the skin pattern of a human. Such a shape is provided to minimize the contact area in contact with the ball stud 10.

When a standardized shape (for example, a circular shape) of a dimple is formed similar to the conventional art, a reduction in contact area with the ball stud 10 is limited.

In the present invention, the spherical inner surface 21 of the ball seat 20 has a plurality of irregular concave features densely disposed such that the spherical inner surface 21 is in point or line contact with an outer circumference 10a of the ball stud 10.

Accordingly, since the ball stud 10 and the spherical inner surface 21 of the ball seat 20 are in simultaneous surface, point and line contact with each other, a contact area is minimized.

Lubrication oil is filled between the outer circumference 10a of the ball stud 10 and the spherical inner surface 21 of the ball seat 20 to reduce friction force therebetween.

Hereinafter, a method of manufacturing the ball seat 20 will be described.

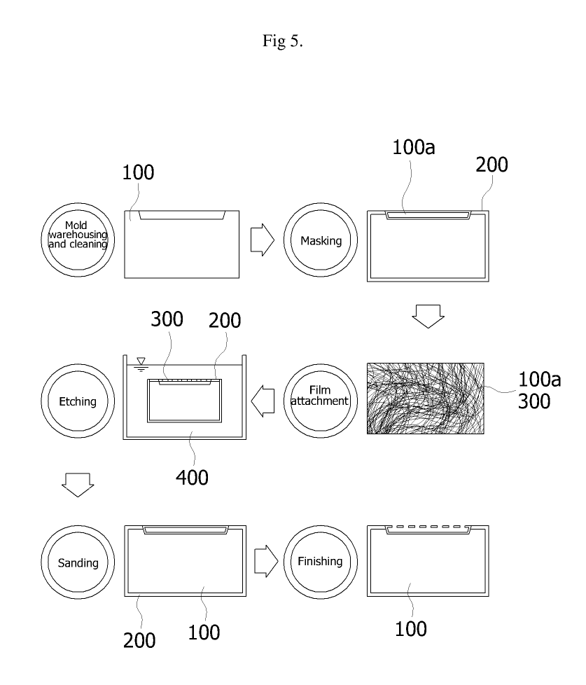

FIG. 5 is a flowchart showing a method of manufacturing a ball seat of the present invention.

When a mold core 100 for manufacturing the ball seat 20 is warehoused, the state of the warehoused mold core 100 is checked, and foreign substances such as dust on a surface of the mold are removed.

Next, other parts of the mold core 100, except for a processed portion 100a in which the spherical inner surface 21 of the ball seat 20 is formed, are covered by a masking tape.

The processed portion 100a is coated with a coating 300 reacting with an ultraviolet light or laser, and a film having a black/white pattern region to be formed is adhered on the coating 300. The coating 300 and the film may be integrally formed with each other.

In this state, an ultraviolet light or laser is irradiated to perform development. Since the ultraviolet light or laser cannot pass through the black region, the coating 300 has no reaction. In addition, the ultraviolet light or laser can pass through the white (transparent) region to react with the coating 300.

The mold core 100 passed through the development is reacted with a chemical solution 400 to etch a region of the coating 300 reacted with the ultraviolet light or laser.

Here, the chemical solution 400 may be an acidic solution or an alkaline solution. When the mold core 100 is formed of steel, the mold core 100 is reacted with the acidic solution to be easily etched, and when the mold core 100 is formed of aluminum, the mold core 100 is reacted with the alkaline solution to be easily etched.

The acidic solution may include sulfuric acid, hydrochloric acid, nitric acid, or a mixture thereof. As acidity is high, reaction is also increased. The alkaline solution may include sodium hydroxide. As alkalinity is high, reaction is also increased. In consideration of reaction conditions, appropriate ranges of acidic and alkaline concentrations may be selected.

After etching, the mold core 100 is surface-abraded by an abrasive to adjust gloss of a product, and any abnormalities in the etching are checked after the removal of the masking tape.

The spherical inner surface 21 of the ball seat 20 is formed using the mold core 100 manufactured through the chemical etching method as described above. Since the ball seat 20 is formed of a plastic material, the ball seat 20 is manufactured through a plastic injection process.

The spherical inner surface 21 of the ball seat 20 manufactured through the above-described process has the same shape as the black/white pattern formed on the coating 300. That is, the spherical inner surface 21 corresponding to the white (transparent) region of the coating 300 on which the etching occurred becomes a concave region, and the spherical inner surface 21 corresponding to the black region of the coating 300 on which the etching did not occur becomes an irregular convex shape.

The chemical etching method has an advantage in that it is capable of easily manufacturing a pattern, which is to be formed on the spherical inner surface 21 of the ball seat 20, by etching the coating 300.

While the chemical etching method has been described as above, a method of forming the spherical inner surface 21 of the ball seat 20 in an irregular shape is not limited thereto, but a physical processing method of manufacturing the spherical inner surface 21 of the ball seat 20 in an irregular shape by applying energy or external force to the processed portion 100a of the mold core 100 may be used.

First, the processed portion 100a of the metal core 100 may be formed through a mechanical process by engraving. However, this method is time consuming and less effective than the chemical etching method.

Next, the processed portion 100a of the mold core 100 may be processed through laser processing or sand blasting by applying energy or external force. An irregular concave portion may be formed by applying a laser to form the processed portion 100a of the mold core 100 into an irregular concave shape, or by injecting emery powder into the processed part 100a of the mold core 100.

Since the spherical inner surface 21 of the ball seat 20 made by the above-described chemical or physical method may be in point or line contact with the outer circumference of the ball stud 10 at a large number of positions, a contact area can be remarkably reduced to decrease the torque of the ball joint.

The following table shows the results in which torques of the conventional product and the etched product in accordance with the present invention are compared.

| | | One day | 10 days | 20 days | 30 days |
|---|---|---|---|---|---|
| | | after | after | after | after |
| | | assembly | assembly | assembly | assembly |
| Conventional | Starting | 64.4 | 84.9 | 114.7 | 106.8 |
| product | torque | | | | |
| | Operating | 22.5 | 12.2 | 21 | 19.4 |
| | torque | | | | |
| Etched | Starting | 70.4 | 58 | 71.8 | 70.4 |
| product | torque | | | | |
| | Operating | 25 | 17.8 | 22.4 | 20 |
| | torque | | | | |

Reviewing the above table, it will be appreciated that the starting torque was 64.4 one day after assembly of the conventional ball joint, and was increased to 106.8 30 days after assembly. In addition, it will be appreciated that the starting torque of the ball joint was uniform at 70.4 both one day and 30 days after assembly. It has been shown that, in comparison with the starting torque 30 days after the assembly of the ball joint, the starting torque of the etched product of the present invention was remarkably smaller than that of the conventional art.

The foregoing description concerns an exemplary embodiment of the invention, is intended to be illustrative, and should not be construed as limiting the invention. The present teachings can be readily applied to other types of devices and apparatuses. Many alternatives, modifications, and variations within the scope and spirit of the present invention will be apparent to those skilled in the art.

### INDUSTRIAL APPLICABILITY

As can be seen from the foregoing, since a spherical inner surface of a bearing has an irregular shape to be in point or line contact with a ball stud so that a contact area between the ball stud and the bearing can be remarkably reduced, the torque of a ball joint can be reduced and performance of the ball joint as a spherical joint can be improved to increase handling recovery force, steering performance and the overall feel of riding a vehicle.

1. A ball joint including
a ball stud, acting as a spherical joint, and
a ball seat in which the ball stud is seated, wherein a spherical inner surface of the ball seat has a plurality of irregular concave features densely disposed and in point or line contact with an outer circumference of the ball stud.

2. The ball joint according to claim 1, including lubrication oil between the outer circumference of the ball stud and the spherical inner surface of the ball seat.

3. A method of manufacturing a ball seat having a spherical inner surface in which a ball stud, acting as a spherical joint, is seated, comprising:
a) forming a plurality of densely arranged irregular concave features in a processed portion of a mold core, for molding the spherical inner surface of the ball seat, by etching with a chemical solution; and
b) forming the spherical inner surface of the ball seat using the mold core having the irregular concave features.

4. The method according to claim 3, wherein a) comprises:
covering portions of the mold core, except for the processed portion, with a masking tape;
coating the processed portion with a coating reacting with ultraviolet light or laser light and irradiating the coating with ultraviolet light or laser light such that the coating reacts in an irregular pattern; and
reacting the region of the processed portion irradiated with the ultraviolet light or the laser light with the chemical solution.

5. The method according to claim 3, including forming the mold core of steel, wherein the chemical solution is an acidic solution including at least one of sulfuric acid, hydrochloric acid, and nitric acid.

6. The method according to claim 3, including forming the mold core of aluminum or magnesium, wherein the chemical solution is an alkaline solution including sodium hydroxide.

7. A method of manufacturing a ball seat having a spherical inner surface in which a ball stud, acting as a spherical joint, is seated, comprising:
a) forming a plurality of densely arranged irregular concave features in a processed portion of a mold core, for molding the spherical inner surface of the ball seat, by a physical process through application of one of energy and an external force to the processed portion; and
b) forming the spherical inner surface of the ball seat using the mold core having the irregular concave features.

8. The method according to claim 7, wherein the physical process is one of laser processings and sand blasting.

9. The method according to claim 3, including forming the processed portion of the mold core to place the ball seat in point or line contact with the ball stud.

10. The method according to claim 4, including forming the mold core of steel, wherein the chemical solution is an acidic solution including at least one of sulfuric acid, hydrochloric acid, and nitric acid.

11. The method according to claim 4, including forming the mold core of aluminum or magnesium, wherein the chemical solution is an alkaline solution including sodium hydroxide.

12. The method according to claim 4, including forming the processed portion of the mold core to place the ball seat in point or line contact with the ball stud.

13. The method according to claim 7, including forming the processed portion of the mold core to place the ball seat in point or line contact with the ball stud.

14. The method according to claim 8, including forming the processed portion of the mold core to place the ball seat in point or line contact with the ball stud.
